(19) United States
(12) Patent Application Publication
(10) Pub. No.: US 2014/0181035 A1
(43) Pub. Date: Jun. 26, 2014

(54) DATA MANAGEMENT METHOD AND INFORMATION PROCESSING APPARATUS

(71) Applicant: FUJITSU LIMITED, Kawasaki-shi (JP)

(72) Inventors: Hiroki Moue, Kawasaki (JP); Yuichi Tsuchimoto, Kawasaki (JP); Miho Murata, Kawasaki (JP)

(73) Assignee: FUJITSU LIMITED, Kawasaki-shi (JP)

(21) Appl. No.: 14/071,051

(22) Filed: Nov. 4, 2013

(30) Foreign Application Priority Data
Dec. 20, 2012 (JP) 2012-278390

(51) Int. Cl. G06F 17/30

(52) U.S. Cl. CPC G06F 17/30312
USPC 707/647

(57) ABSTRACT

A first node is assigned a first data group, and a second node is assigned a second data group. In addition, the second node manages a backup copy of the first data group. The second node receives, from the first node, a log indicating an instruction executed on a data record belonging to the first data group, and stores the received log in a memory of the second node. The second node writes logs for a plurality of instructions accumulated in the memory into a storage device of the second node different from the memory when a predetermined condition is satisfied.

### CROSS-REFERENCE TO RELATED APPLICATION

This application is based upon and claims the benefit of priority of the prior Japanese Patent Application No. 2012-278390, filed on Dec. 20, 2012, the entire contents of which are incorporated herein by reference.

### FIELD

The embodiments discussed herein are related to a data management method and an information processing apparatus.

### BACKGROUND

Distributed storage systems have been currently in use which store, in a distributed manner, data in a plurality of nodes connected via a network. One example of the distributed storage systems is a distributed key-value store where each node stores therein pairs of a key and a value as data records. In the distributed key-value store, a node to store each key-value pair is determined from among a plurality of nodes based on, for example, a hash value for the key.

In such a distributed storage system, data may be copied and stored in a plurality of nodes in case of failures in up to a predetermined number of nodes. For example, storing the same data across three nodes protects against a simultaneous failure in up to two nodes. In the case where data are stored redundantly, among a plurality of nodes storing the same data, only one node may receive read and write instructions for the data and execute processing accordingly while the remaining nodes primarily manage the data as backup data. Such execution of processing in response to an instruction may be referred to as a master process, and the management of backup data may be referred to as a slave process. In order to use resources of a plurality of nodes, each node may be in charge of the master process for some data while being in charge of the slave process for other data, instead of dedicated nodes being provided for the master process and for the slave process.

Note that a system has been proposed in which each of a plurality of nodes includes a master processor, a slave processor, and a common memory shared by the master and the slave processor, and the individual master processors are directly monitored via a bus connecting the plurality of nodes and the individual slave processors are indirectly monitored via the common memories. In addition, another proposed system includes two home location registers (HLR) each for handling messages of its associated subscribers, and if one of the HLRs fails, the other HLR undertakes the processing of the failed HLR by copying the messages handled by the failed HLR. Yet another proposed technology is directed to a system in which a plurality of resource management apparatuses is individually provided with a reservation database for storing resource request information and the reservation databases are shared by the resource management apparatuses.

Japanese Laid-open Patent Publication No. H7-93270

Japanese Laid-open Patent Publication No. H10-512122

Japanese Laid-open Patent Publication No. 2011-203848

As for a distributed storage system storing data redundantly, after executing a write instruction for data, a node in charge of the master process for the data causes a node in charge of the slave process for the data to reflect the write operation. However, it is often the case that non-volatile storage devices providing relatively slow random access, such as HDDs (hard disk drives), are used for data management. Therefore, the node in charge of the slave process accessing such a non-volatile storage device each time a write instruction for the data is executed may degrade the performance of the master process carried out by the same node on other data. The performance degradation of the master process reduces the overall throughput of the entire distributed storage system.

### SUMMARY

According to one aspect, there is provided a non-transitory computer-readable storage medium storing a computer program causing a computer to perform a process, which computer is used as a second node in a system including a first node responsible for a first data group and the second node responsible for a second data group and managing a backup copy of the first data group. The process includes receiving, from the first node, a log indicating an instruction executed on a data record belonging to the first data group, and storing the received log in a memory of the computer; and writing logs for a plurality of instructions accumulated in the memory into a storage device of the computer different from the memory when a predetermined condition is satisfied.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of an information processing system according to a first embodiment;

FIG. 2 illustrates an example of an information processing system according to a second embodiment;

FIG. 3 illustrates an example of data allocation;

FIG. 4 illustrates an example of a change in the data allocation for a case of a node failure;

FIG. 5 is a block diagram illustrating an example of a hardware configuration of each node;

FIG. 6 is a block diagram illustrating an example of functions of each node;

FIG. 7 illustrates an example of a node management table;

FIG. 8 is a flowchart illustrating a procedure example of a master process;

FIG. 9 is a flowchart illustrating a procedure example of a slave process;

FIG. 10 is a flowchart illustrating a procedure example of redundancy restoration;

FIG. 11 illustrates a first example of communication among nodes;

FIG. 12 illustrates a second example of communication among nodes;

FIG. 13 illustrates a third example of communication among nodes;

FIG. 14 illustrates another data allocation example;

FIG. 15 illustrates a fourth example of communication among nodes; and

FIG. 16 illustrates a fifth example of communication among nodes.

### DESCRIPTION OF EMBODIMENTS

Several embodiments will be described below with reference to the accompanying drawings, wherein like reference numerals refer to like elements throughout.

### (a) First Embodiment

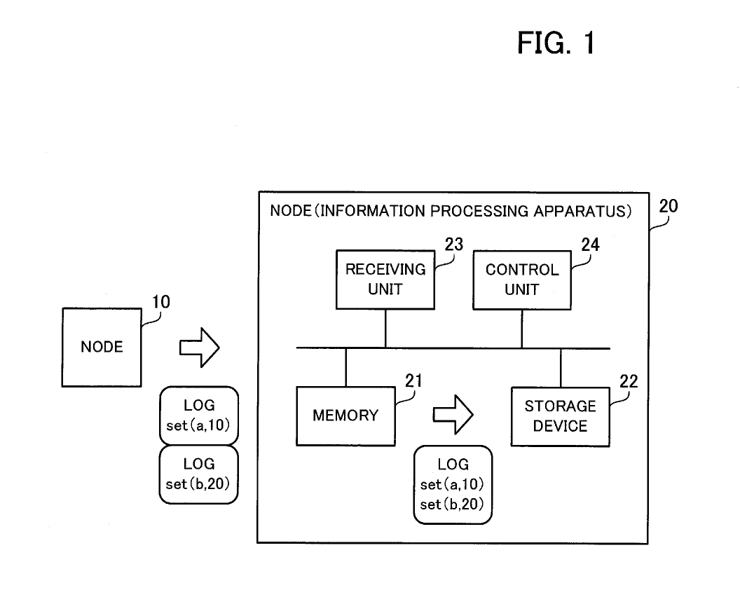

FIG. 1 illustrates an example of an information processing system according to a first embodiment. The information processing system of the first embodiment is provided with a plurality of nodes including nodes 10 and 20. The plurality of nodes is connected to a network, such as a LAN (local area network), and manage data using non-volatile storage devices, such as HDD, in a distributed manner.

The node 10 is assigned a first data group, and the node 20 is assigned a second data group having no overlap with the first data group. Each of the first and second data groups 10 and 20 includes, for example, one or more key-value data records, each of which is a pair of a key and a value. For example, the first data group is a collection of data records with a hash value for each key belonging to a predetermined first range, and the second data group is a collection of data records with a hash value for each key belonging to a predetermined second range which does not overlap the first range.

The node 10 to which the first data group has been assigned receives an instruction designating a data record belonging to the first data group, and executes the received instruction. Examples of types of instructions are write instructions and read instructions. Upon receiving a write instruction designating a data record, the node 10 writes the designated data record into a non-volatile storage device provided in the node 10. In addition, upon receiving a read instruction designating a data record, the node 10 reads the designated data record from the non-volatile storage device of the node 10. Similarly, the node 20 to which the second data group has been assigned receives an instruction designating a data record belonging to the second data group, and executes the received instruction.

In addition, the node 20 manages a backup copy of the first data group. Unlike the node 10, the node 20 does not directly receive and execute an instruction designating a data record belonging to the first data group. That is, it is not the node 20 but the node 10 that reads a data record belonging to the first data group. In addition, a request for storing a data record belonging to the first data group is made not to the node 20 but to the node 10.

Note that the process of receiving and executing an instruction may be referred to as a master process, and the process of managing a backup copy may be referred to as a slave process. The node 10 is in charge of the master process for the first data group, and the node 20 is in charge of the slave process for the first data group and the master process for the second data group. Note also that a node in charge of the master process for a data group may be referred to as a master node of the data group, and a node in charge of the slave process for a data group may be referred to as a slave node of the data group. For the first data group, the node 10 is the master node and the node 20 is the slave node. In addition, for the second data group, the node 20 is the master node.

As for the first data group, after executing a write instruction, the node 10 functioning as the master node needs to cause the node 20 functioning as the slave node to reflect a result of the write operation in order to maintain data redundancy. Therefore, the node 10 transmits a log indicating the executed instruction to the node 20. Instructions to be reported as logs may be all types of instructions including read instructions, or may be limited to predetermined types of instructions, such as write instructions.

The node 20 serving as an information processing apparatus includes a memory 21, a storage device 22, a receiving unit 23, and a control unit 24. The memory 21 is a volatile storage device, such as a RAM (random access memory). The storage device 22 is a non-volatile storage device, such as a HDD, providing slower random access than the memory 21. The receiving unit 23 is, for example, a communication interface for connecting to a network either with a wire or wirelessly. The control unit 24 includes, for example, a processor. The ‘processor’ may be a CPU (central processing unit) or a DSP (digital signal processor), or an electronic circuit designed for specific use, such as an ASIC (application specific integrated circuit) and an FPGA (field programmable gate array). Alternatively, the ‘processor’ may be a set of multiple processors (multiprocessor). The processor executes a program stored in a volatile memory, such as a RAM.

The receiving unit 23 receives, from the node via the network, a log indicating an instruction executed by the node 10 (preferably, a write instruction) on a data record belonging to the first data group. Such a log is sequentially received, for example, each time a predetermined type of instruction is executed.

Each time a log is received, the control unit 24 adds the received log to a buffer area in the memory 21. For example, when a log for a write instruction designating key=a and value=10 is received, the control unit 24 adds the log to the buffer area in the memory 21. Subsequently, when a log for a write instruction designating key=b and value=20 is received, the control unit 24 also adds the log to the buffer area in the memory 21. In this manner, logs for a plurality of instructions are accumulated in the memory 21.

Subsequently, when a predetermined condition is satisfied, the control unit 24 writes the logs for the plurality of instructions accumulated in the memory 21 into the storage device 22. The logs for the plurality of instructions may be sequentially written into a continuous storage area in the storage device 22. The logs once stored in the storage device 22 may be deleted from the memory 21. For example, the control unit 24 collectively transfers, from the memory 21 to the storage device 22, the log for the write instruction designating key=a and value=10 and the log for the write instruction designating key=b and value=20, which logs have been received separately.

As the predetermined condition to determine the timing for writing the logs into the storage device 22, for example, the magnitude of the load on the node 20 may be used. In this case, the control unit 24 monitors the load on the node 20 and, then, writes the logs into the storage device 22 when the load has dropped to less than a threshold. To determine the load on the node 20, the control unit 24 may monitor, for example, CPU utilization, or access frequency to a non-volatile storage device (for example, the storage device 22) associated with the master process. In addition, as the predetermined condition, for example, the amount of logs stored in the buffer area of the memory 21 may be used. In this case, the control unit 24 monitors the buffer area and, then, writes the logs in the buffer area into the storage device 22 when the amount of logs has reached a threshold.

Note that the logs written into the storage device 22 may be used to restore the first data group in case of a failure in the node 10. For example, the node 20 re-executes instructions on a backup copy of an old first data group held therein, to thereby restore the latest first data group. This enables the node 20 to become a new master node in place of the node 10. In addition, the logs written into the storage device 22 may be used to restore the redundancy of the first data group in case of a failure in the node 10. For example, the node 20 transmits the logs to a node other than the nodes 10 and 20, to thereby designate the node as a new slave node of the first data group. Note however that the node 20 may re-execute the instructions prior to a failure of the node 10 when the load on the node 20 is low.

According to the information processing system of the first embodiment, data processing load is distributed between the nodes 10 and 20 because the node 10 executes instructions each designating a data record belonging to the first data group and the node 20 executes instructions each designating a data record belonging to the second data group. In addition, the node 20 manages a backup copy of the first data group having been assigned to the node 10 to thereby provide data redundancy. Therefore, even if one of the nodes 10 and 20 fails, the other node is able to continue the processing of the first data group, thus improving fault tolerance.

In addition, when the node 10 has executed a write instruction for a data record belonging to the first data group, a corresponding log is accumulated in the node 20 instead of the same write instruction being immediately executed in the node 20. Then, when a failure has occurred in the node 10 (or when the load on the node 20 is low), write instructions are re-executed in the node 20 according to accumulated logs. This reduces the load on the node 20 for managing a backup copy of the first data group.

Further, logs are accumulated in the memory 21 rather than each log being written into the storage device 22 when the log is transmitted from the node 10 to the node 20, and the accumulated logs are collectively written into the storage device 22 when a predetermined condition is satisfied. This reduces access to the storage device 22 in relation to the backup copy management, and therefore, it is possible to reduce the likelihood that access to the storage device 22 associated with other processing will be placed in a wait state, even if the storage device 22 provides slow random access. This in turn lowers the possibility of reducing the performance of the node 20 to process a data record belonging to the second data group, thus improving the processing throughput.

### (b) Second Embodiment

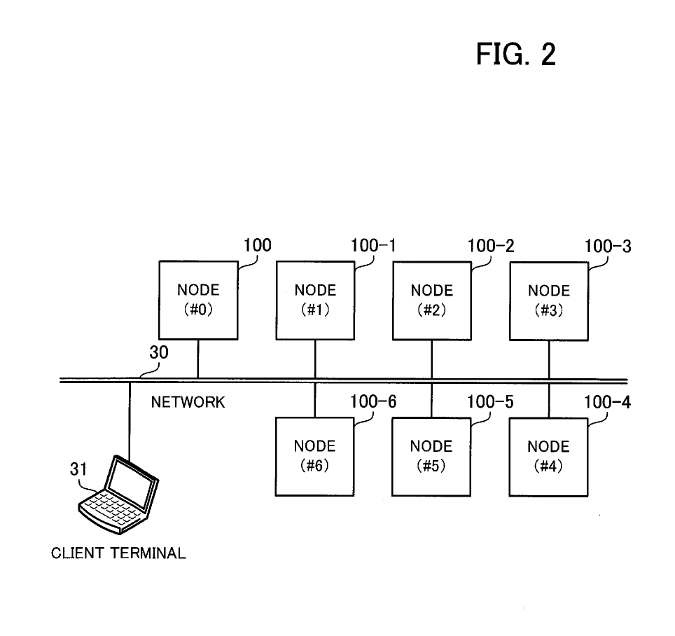

FIG. 2 illustrates an example of an information processing system according to a second embodiment. The information processing system of the second embodiment manages data by distributing them across a plurality of nodes. The information processing system includes a client terminal 31 and nodes 100 and 100-1 to 100-6. The client terminal 31 and the individual nodes are connected to a network 30.

The client terminal 31 is a computer functioning as terminal equipment operated by a user. To read or write a data record, the client terminal 31 accesses one of the nodes 100 and 100-1 to 100-6. At this point, any node may be selected as an access target regardless of the content of the data record. That is, the information processing system does not have a centralized management node which is a potential bottleneck, and all the nodes are available to be accessed by the client terminal 31. In addition, the client terminal 31 need not know which node stores the desired data record.

Each of the nodes 100 and 100-1 to 100-6 is a server computer for managing data by storing them in a non-volatile storage device. The nodes 100 and 100-1 to 100-6 store data, for example, in a key-value format in which each data record is a pair of a key and a value. In this case, a collection of the nodes 100 and 100-1 to 100-6 may be referred to as a distributed key-value store.

According to the information processing system of the second embodiment, data are stored redundantly across a plurality of (for example, two) nodes in order to enhance fault tolerance. Among the plurality of nodes storing the same data therein, one node handles access to the data by the client terminal 31 and the remaining nodes primarily manage the data as backup copies. The processing of the former node may be referred to as a master process while the processing of the latter nodes may be referred to as a slave process. In addition, a node in charge of the master process for data may be referred to as a master node of the data, and a node in charge of the slave process for data is referred to as a slave node of the data. Each node may undertake both a master process and a slave process. In that case, the node is a master node (i.e., is in charge of the master process) of some data, and is at the same time a slave node (is in charge of the slave process) of some other data. Note that the backup copies are not available to be read in response to a read instruction issued by the client terminal 31. Note however that when data of a master node (original data corresponding to the backup copies) are updated in response to a write instruction issued by the client terminal 31, the backup copies may be updated in order to maintain data consistency.

Based on hash values for keys, each node is assigned data for which the node is to be in charge of the master process and data for which the node is to be in charge of the slave process. When a node is accessed by the client terminal 31, the node calculates a hash value for a key designated by the client terminal 31, and determines a master node in charge of the master process for a data record indicated by the key. In the case where the determined master node is a different node, the access is transferred to the different node.

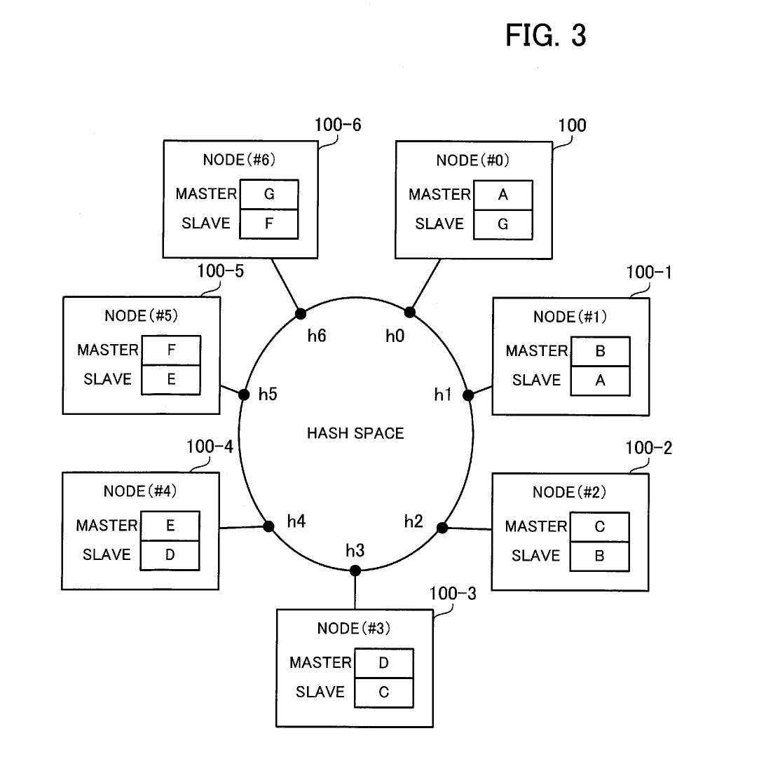

FIG. 3 illustrates an example of data allocation. When data are allocated to the nodes 100 and 100-1 to 100-6, a hash space is defined in which the range of hash values for keys is treated as a circular space, as illustrated in FIG. 3. For example, in the case where the hash value for a given key is represented in L bits, the largest hash value 2^{L}−1 wraps around to the smallest hash value 0 in the circular hash space.

Each node is assigned a position (i.e., hash value) in the hash space. The hash value corresponding to each node is, for example, a hash value of an address of the node, such as an IP (Internet Protocol) address. In the example of FIG. 3, hash values h0 to h6 corresponding to the nodes 100 and 100-1 to 100-6, respectively, are set in the hash space. Then, a master node and a slave node are assigned to each region between hash values of two neighboring nodes. For example, each node is in charge of the master process for data belonging to a region in the hash space between the node and its immediate predecessor. In addition, for example, a successor located immediately after a node in charge of the master process for data is in charge of the slave process for the data.

Assuming as an example that h( ) is a hash function and the smallest hash value 0 is located between h6 and h0, the node 100 is in charge of the master process for data record A belonging to a region h6<h(key)≦2^{L}−1 or a region 0≦h(key) and the node 100-1 is in charge of the slave process for data record A. In addition, the node 100-1 is in charge of the master process for data record B belonging to a region h0<h(key)≦h1, and the node 100-2 is in charge of the slave process for data record B. Similarly, the node 100-2 is in charge of the master process for data record C belonging to a region h1<h(key)≦h2, and the node 100-3 is in charge of the slave process for data record C.

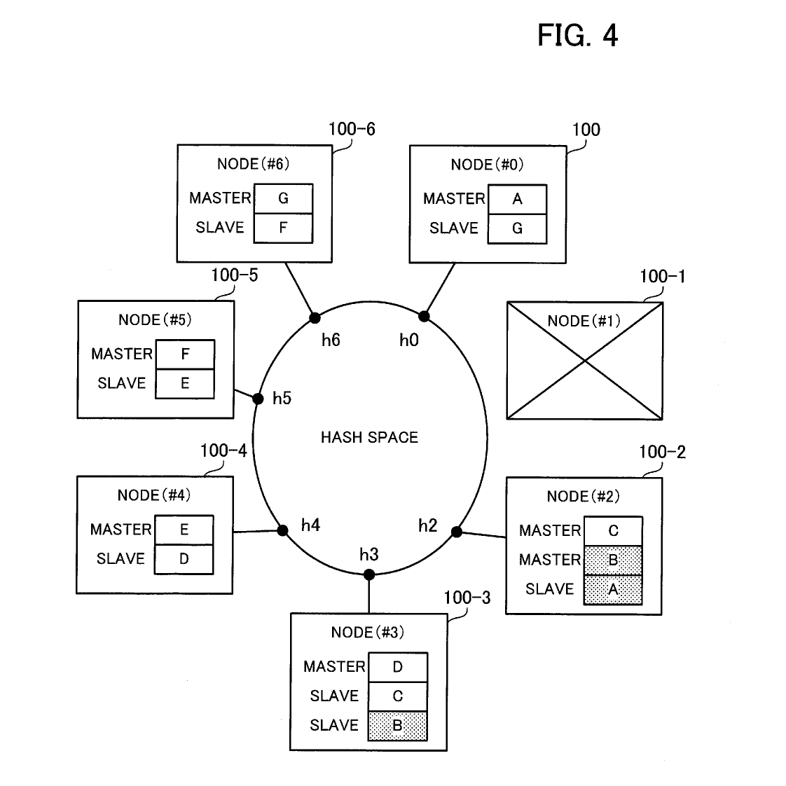

FIG. 4 illustrates an example of a change in data allocation for a case of a node failure. When a failure has occurred in a node, a node located in the hash space immediately after the failed node undertakes the master process and the slave process of the failed node. This involves a change in the data allocation to nodes. Note however that only some, not all, of the nodes of the information processing system are affected by the node failure. For example, in the case where the same data are stored across N nodes (that is, the redundancy is N), N nodes located after the failed node are affected.

Assuming as an example that a failure has occurred in the node 100-1, the node 100-2 undertakes the master process for data record B and the slave process for data record A. Since originally being the slave node of data record B, the node 100-2 need not acquire data record B from another node. On the other hand, in order to become a new slave node of data record A, the node 100-2 acquires data record A from the node 100, which becomes an immediate predecessor of the node 100-2 in the hash space after the failed node 100-1 is removed. Since the node 100-2 becomes the master node of data record B, the node 100-3 undertakes the slave process for data record B. In order to become a new slave node of data record B, the node 100-3 acquires data record B from the node 100-2 which is an immediate predecessor of the node 100-3 in the hash space.

When data writing has been executed in a master node according to a request of the client terminal 31, the master node needs to cause its slave node to reflect the result of the write operation to thereby maintain data redundancy. In order to achieve this, according to the information processing system of the second embodiment, the master node transmits a log to the slave node each time data writing is executed.

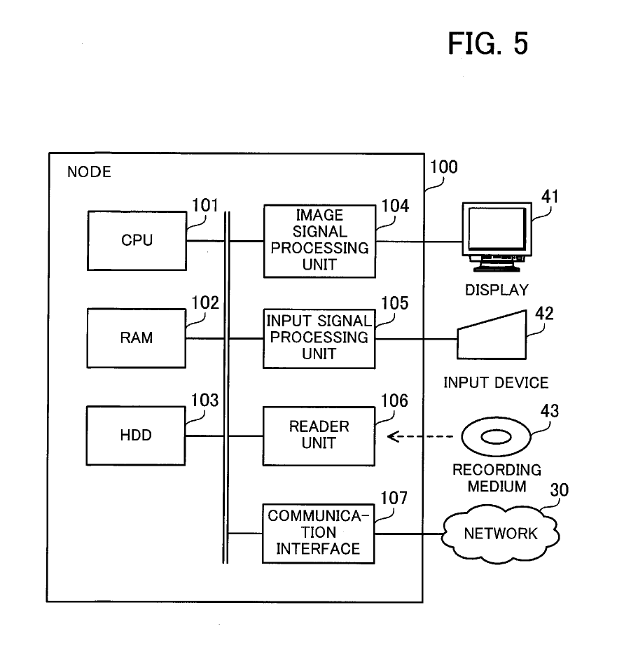

FIG. 5 is a block diagram illustrating an example of a hardware configuration of each node. The node 100 includes a CPU 101, a RAM 102, a HDD 103, an image signal processing unit 104, an input signal processing unit 105, a reader unit 106, and a communication interface 107.

The CPU 101 is a processor for executing instructions of programs. The CPU 101 loads, into the RAM 102, at least part of programs and data stored in the HDD 103 to implement the programs. Note that the CPU 101 may include multiple processor cores and the node 100 may include multiple processors, and processes described later may be executed in parallel using multiple processors or processor cores. In addition, a set of multiple processors (multiprocessor) may be referred to as a ‘processor’.

The RAM 102 is a volatile memory for temporarily storing therein programs to be executed by the CPU 101 and data to be used in information processing. Note that the node 100 may be provided with a different type of memory other than RAM, or may be provided with multiple types of memories.

The HDD 103 is a nonvolatile storage device to store therein software programs for, for example, an OS (operating system), middleware, and application software, and various types of data. Note that the node 100 may be provided with a different type of nonvolatile storage device, such as an SSD (solid state drive), or may be provided with multiple types of non-volatile storage devices.

The image signal processing unit 104 outputs an image on a display 41 connected to the node 100 according to an instruction from the CPU 101. Various types of displays including the following may be used as the display 41: CRT (cathode ray tube) display; LCD (liquid crystal display); plasma display panel (PDP); and GELD (organic electro-luminescence) display.

The input signal processing unit 105 acquires an input signal from an input device 42 connected to the node 100 and sends the input signal to the CPU 101. Various types of input devices including the following may be used as the input device 42: pointing device, such as mouse, touch panel, touch-pad, and trackball; keyboard; remote controller; and button switch. In addition, the node 100 may be provided with multiple types of input devices.

The reader unit 106 is a media interface for reading programs and data recorded in a recording medium 43. As for the recording medium 43, any of the following may be used: magnetic disk, such as flexible disk (FD) and HDD; optical disk, such as CD (compact disc) and DVD (digital versatile disc); and magneto-optical disk (MO). In addition, a non-volatile semiconductor memory, such as a flash memory card, may be used as the recording medium 43. The reader unit 106 stores programs and data read from the recording medium 43 in the RAM 102 or the HDD 103, for example, according to instructions from the CPU 101.

The communication interface 107 communicates with the client terminal 31 and other nodes via the network 30. The communication interface 107 may be a wired communication interface connected with a communication cable, or a wireless communication interface for communicating wirelessly using a transmission medium such as radio waves and optical waves.

Note however that the node 100 may be configured without the reader unit 106, and further may be configured without the image signal processing unit 104 and the input signal processing unit 105 in the case where user operations may be performed on the node 100 from a different apparatus, such as the client terminal 31. In addition, the display 41 and the input device 42 may be integrally provided on the chassis of the node 100, or may be connected wirelessly. Note that the client terminal 31 and the nodes 100-1 to 100-6 may be constructed with the same hardware configuration as described above.

Note that the CPU 101 is an example of the control unit 24 of the first embodiment; the RAM 102 is an example of the memory 21 of the first embodiment; the HDD 103 is an example of the storage device 22 of the first embodiment; and the communication interface 107 is an example of the receiving unit 23 of the first embodiment.

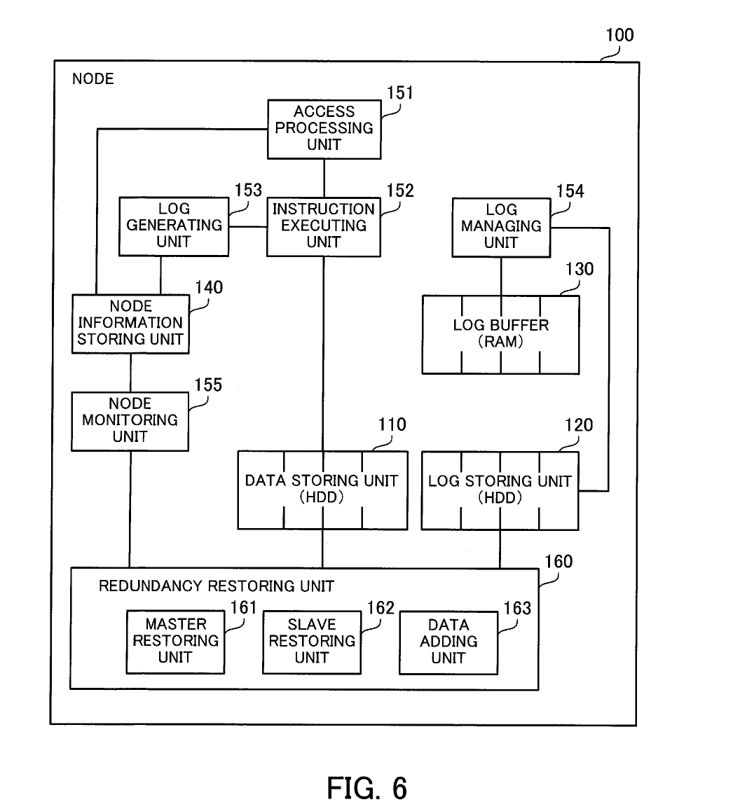

FIG. 6 is a block diagram illustrating an example of functions of each node. The node 100 includes a data storing unit 110, a log storing unit 120, a log buffer 130, a node information storing unit 140, an access processing unit 151, an instruction executing unit 152, a log generating unit 153, a log managing unit 154, a node monitoring unit 155, and a redundancy restoring unit 160. The redundancy restoring unit 160 includes a master restoring unit 161, a slave restoring unit 162, and a data adding unit 163.

The data storing unit 110 is a non-volatile storage area reserved in the HDD 103. The data storing unit 110 stores therein key-value data records, each of which is a pair of a key and a value. The data storing unit 110 is divided into a plurality of storage areas according to the keys. For example, data records having similar keys are stored adjacent to each other.

The log storing unit 120 is a non-volatile storage area reserved in the HDD 103. The log storing unit 120 stores therein logs for write instructions received from another node and yet to be reflected in the data storing unit 110. The log storing unit 120 is divided into a plurality of storage areas corresponding to the divided storage areas of the data storing unit 110. For example, logs indicating write instructions for data records to be written adjacent to each other in the data storing unit 110 (for example, logs indicating write instructions for data records having similar keys) are stored collectively in a corresponding storage area of the log storing unit 120.

The log buffer 130 is a volatile storage area reserved in the RAM 102. The log buffer 130 temporarily accumulates logs received from another node but yet to be stored in the log storing unit 120. The log buffer 130 is divided into a plurality of buffer areas corresponding to the divided storage areas of the log storing unit 120. For example, logs indicating write instructions for data records to be written adjacent to each other in the data storing unit 110 (for example, logs for write instructions for data records having similar keys) are accumulated collectively in a corresponding buffer area of the log buffer 130.

The node information storing unit 140 is a storage area reserved in the RAM 102 or the HDD 103. The node information storing unit 140 stores therein node information indicating allocation of data to the nodes 100 and 100-1 to 100-6. For example, the node information indicates correspondence between regions of hash values for keys and master nodes. In the case where slave nodes are determined according to the method described in FIG. 3, it is possible to identify a slave node of a data record based on a master node for the data record and a sequence of nodes in the hash space. Therefore, the node information need not include information indicating correspondence between the regions of hash values for keys and slave nodes.

The access processing unit 151 receives, as access from the client terminal 31, a data manipulation instruction issued by the client terminal 31 from the client terminal 31 or another node via the network 30. Types of data manipulation instructions include read instructions each designating a key and write instructions each designating a key and a value. The access processing unit 151 calculates a hash value based on a key designated in the data manipulation instruction, and searches for a master node by which the data manipulation instruction is to be executed, with reference to the node information stored in the node information storing unit 140. In the case where the master node found in the search is the node 100, the access processing unit 151 outputs the data manipulation instruction to the instruction executing unit 152. On the other hand, if the found master node is another node, the access processing unit 151 transfers the data manipulation instruction to the found master node.

The instruction executing unit 152 executes the data manipulation instruction acquired from the access processing unit 151, and then transmits a response message indicating the execution result to the client terminal 31. That is, in the case where the data manipulation instruction is a read instruction, the instruction executing unit 152 reads a data record indicated by the designated key from the data storing unit 110, and then transmits the read data record to the client terminal 31. In the case where the data manipulation instruction is a write instruction, the instruction executing unit 152 selects one of the divided storage areas in the data storing unit 110 according to the designated key, and writes a value in association with the key into the selected storage area. At this point, the instruction executing unit 152 may or may not write the key together with the value depending on the data structure of the data storing unit 110.

When the instruction executing unit 152 has executed a write instruction, the log generating unit 153 generates a log indicating the executed write instruction (for example, a log indicating a key-value pair). In addition, the log generating unit 153 searches for a slave node of the written data record with reference to the node information stored in the node information storing unit 140. Then, the log generating unit 153 transmits the generated log to the slave node via the network 30.

Note that only logs indicating write instructions are transmitted according to the above description, however, logs indicating other instructions, such as read instructions, may also be transmitted in addition to the logs indicating write instructions. In addition, the log generating unit 153 transmits the generated log to the slave node either before or after the instruction execution unit 152 transmits the response message indicating the execution result of a corresponding data manipulation instruction to the client terminal 31. In addition, the log generating unit 153 may store, in the node 100, a copy of each log indicating a write instruction.

The log managing unit 154 receives a log of a write instruction transmitted from another node. The log managing unit 154 selects one of the divided buffer areas of the log buffer 130 according to a key designated by the write instruction, and adds the log to the selected buffer area. That is, the log managing unit 154 temporarily accumulates the received log in the RAM 102 instead of immediately writing the received log into the HDD 103.

In addition, when a predetermined condition is satisfied, the log managing unit 154 collectively writes all logs accumulated in one of the divided buffer areas in the log buffer 130 into a corresponding storage area of the log storing unit 120. The logs once written into the log storing unit 120 may be deleted from the log buffer 130. In a single write operation for the log storing unit 120, it is possible to sequentially and collectively write logs for a plurality of write instructions received separately in different times. As the predetermined condition, a condition that the amount of logs accumulated in one of the divided buffer areas has reached a threshold is used. In addition, as the predetermined condition, a condition that the load on the node 100 (for example, CPU utilization or input/output (I/O) frequency of the HDD 103) has dropped to less than a threshold is also used.

As for data for which the node 100 is in charge of the master process, if each log is stored also in the master node, the log generating unit 153 may write the log in the log buffer 130 or the log storing unit 120. In that case, the log generating unit 153 may read the log from the log buffer 130 or the log storing unit 120 and then transfer the log to a corresponding slave node. As for data for which the node 100 is in charge of the slave process, the log managing unit 154 may transfer each log stored in the log buffer 130 or the log storing unit 120 further to another node.

The processing of the access processing unit 151, the instruction executing unit 152, and the log generating unit 153 corresponds to the master process. In addition, the processing of the log managing unit 154 corresponds to the slave process. It is preferable to place a higher priority on the master process of the node 100 while giving less priority on the slave process. In addition, logs are written into the log storing unit 120 preferably when the CPU utilization or the I/O frequency associated with the master process is low.

The node monitoring unit 155 monitors whether other nodes participating in the distributed data management (the nodes 100-1 to 100-6) are normally operating. For example, the node monitoring unit 155 periodically transmits a message to the other nodes, and then determines, as a failed node, a node not returning a response within a specified period of time after the message transmission. Upon detecting a failed node, the node monitoring unit 155 calculates data allocation according to the method described in FIG. 4 and updates the node information stored in the node information storing unit 140.

In addition, the node monitoring unit 155 requests the redundancy restoring unit 160 to restore data redundancy if the failed node is the slave node of data for which the node 100 is in charge of the master process, or is the master node of data for which the node 100 is in charge of the slave process. In response to a request from the node monitoring unit 155 or another node, the redundancy restoring unit 160 restores redundancy of data having been allocated to a failed node.

In the case where a failure has occurred in the master node of data for which the node 100 is in charge of the slave process, the master restoring unit 161 operates to turn the node 100 into a new master node for the data in place of the failed node. In addition, the master restoring unit 161 operates to turn another normal node into a new slave node for the data in place of the node 100. The new slave node may be determined, for example, according to the method described in FIGS. 3 and 4.

To turn the node 100 into the master node, the master restoring unit 161 reads logs from the log storing unit 120 and writes data records into the data storing unit 110 by re-executing write instructions indicated by the logs. In the log storing unit 120, logs for a plurality of write instructions have been sorted out to individually correspond to one of the divided storage areas in the data storing unit 110. Therefore, reading and re-executing logs for each of the storage areas in the log storing unit 120 enables successive data writing into locations as close to each other as possible in the data storing unit 110, thereby improving efficiency of access to the HDD 103.

In order to configure a new slave node, the master restoring unit 161 transmits, to the new slave node, logs stored in the log storing unit 120 and relevant data stored in the data storing unit 110, to which relevant data the logs of the log storing unit 120 have yet to be applied. Note however that the master restoring unit 161 may transmit, to the new slave node, data to which the logs of the log storing unit 120 have been applied, in place of the logs and the data prior to the log application.

Note that the master restoring unit 161 may optimize a plurality of write instructions before re-executing them. For example, if the logs include two or more write instructions designating the same key, only the last executed write instruction may be left while all the rest are deleted. The optimization of write instructions may be performed when the log managing unit 154 transfers logs from the log buffer 130 to the log storing unit 120. In addition, the master restoring unit 161 may reflect, in the data storing unit 110, logs stored in the log storing unit 120 when the load on the node 100 is low even if the master node has not failed.

When a failure has occurred in a slave node of data for which the node 100 is in charge of the master process, the slave restoring unit 162 operates to turn another normal node into a new slave node of the data in place of the failed node. The new slave node may be determined, for example, according to the method described in FIGS. 3 and 4. The slave restoring unit 162 transmits relevant data stored in the data storing unit 110 to the new slave node.

By request from another node, the data adding unit 163 operates to turn the node 100 into a new slave node. Upon receiving old data and logs for write instructions from a new master node (former slave node), the data adding unit 163 writes the old data into the data storing unit 110 and writes the logs for write instructions into the log storing unit 120 (or the log buffer 130). Then, the data adding unit 163 re-executes the write instructions indicated by the logs to thereby restore the latest data on the data storing unit 110. In the case of receiving the latest data from the master node, the data adding unit 163 writes the latest data into the data storing unit 110.

Note that the access processing unit 151, the instruction executing unit 152, the log generating unit 153, the log managing unit 154, the node monitoring unit 155, and the redundancy restoring unit 160 may be implemented as modules of a program to be executed by the CPU 101. Note however that part or all of the functions of the modules may be implemented by an ASIC. In addition, the nodes 100-1 to 100-6 also individually have similar modules.

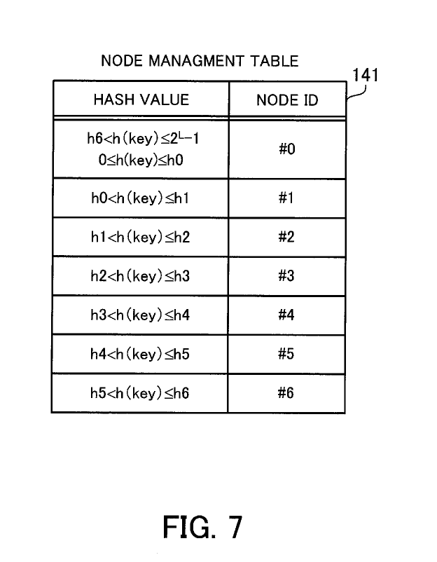

FIG. 7 illustrates an example of a node management table. A node management table 141 is stored in the node information storing unit 140. The node management table 141 includes columns for ‘hash value’ and ‘node ID (identification)’. Each entry in the hash value column is a hash value region in the hash space. Each entry in the node ID column is identification information of a node in charge of the master process (i.e., master node) for data whose hash values for keys belong to a corresponding hash value region. As the identification information of each node, its communication address, such as an IP address, may be used.

A predetermined hash function is applied to a key designated in a data manipulation instruction to thereby calculate a hash value, based on which a master node to execute the data manipulation instruction is found with reference to the node management table 141. In addition, in the case where slave nodes have been determined according to the method described in FIG. 3, a node located immediately after the found master node is identified as a slave node corresponding to the master node with reference to the node management table 141.

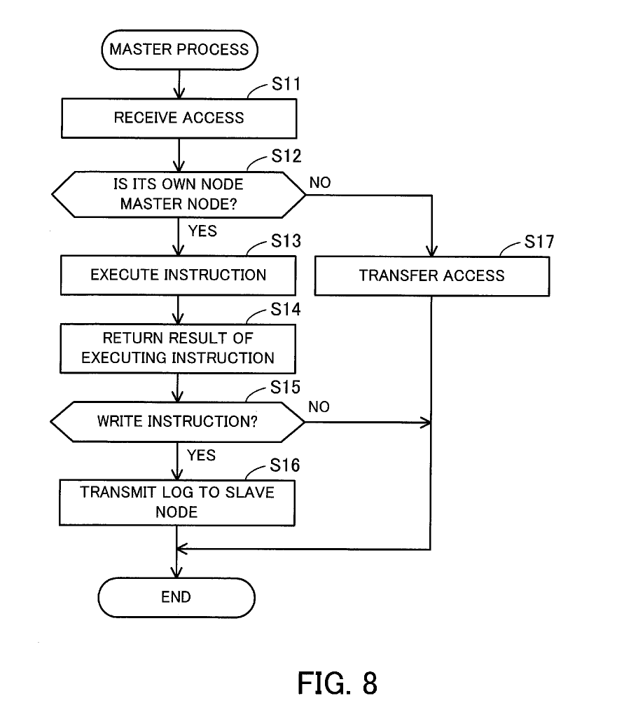

FIG. 8 is a flowchart illustrating a procedure example of a master process. Here, the procedure of the master process is described for the case where the node 100 carries out the master process. The node 100 carries out the master process illustrated in FIG. 8 each time the node 100 receives access. Note that the nodes 100-1 to 100-6 individually carry out a similar master process to that of the node 100.

[Step S11] The access processing unit 151 receives, as access from the client terminal 31, a data manipulation instruction from the client terminal 31 or another node.

[Step S12] The access processing unit 151 calculates a hash value for a key designated in the data manipulation instruction, and then searches the node management table 141 stored in the node information storing unit 140 for a master node corresponding to the hash value. Subsequently, the access processing unit 151 determines whether the found master node is its own node (i.e., the node 100). If the master node is its own node, the process moves to step S13. If not, the process moves to step S17.

[Step S13] The instruction executing unit 152 executes the data manipulation instruction. In the case where the data manipulation instruction is a read instruction, the instruction executing unit 152 reads, from the data storing unit 110, a data record with the key designated in the read instruction. In the case where the data manipulation instruction is a write instruction, the instruction executing unit 152 selects one of the divided storage areas in the data storing unit 110, corresponding to the key. Then, the instruction executing unit 152 writes, into the selected storage area, a pair of the key and a value designated in the write instruction.

[Step S14] The instruction executing unit 152 transmits, to the client terminal 31, a response message indicating the result of executing the data manipulation instruction. In the case of having executed a read instruction, the instruction executing unit 152 transmits the response message including therein the read data. In the case of having executed a write instruction, the instruction executing unit 152 transmits the response message including therein information indicating the success or failure of the write operation.

[Step S15] The log generating unit 153 determines whether the data manipulation instruction executed by the instruction executing unit 152 is a write instruction. If it is a write instruction, the process moves to step S16. If not (for example, it is a read instruction), the master process is ended. Note that when the write operation fails, the master process may be ended instead of moving to step S16.

[Step S16] The log generating unit 153 generates a log indicating the write instruction executed by the instruction executing unit 152. In addition, the log generating unit 153 searches for a slave node corresponding to the hash value for the key with reference to the node management table 141. Then, the log generating unit 153 transmits the generated log to the found slave node. Subsequently, the master process is ended.

[Step S17] The access processing unit 151 transfers the data manipulation instruction representing a data access request to the found master node. Subsequently, the master process is ended.

Note that, as described above, the log generation and transmission (steps S15 and S16) may precede the transmission of the response message to the client terminal 31 (step S14). In addition, as described above, data manipulation instructions recorded as logs are not limited to write instructions, and other types of data manipulation instructions, such as read instructions, may also be recorded as logs. In that case, the slave node may extract a data manipulation instruction from each received log only if the data manipulation instruction is a write instruction.

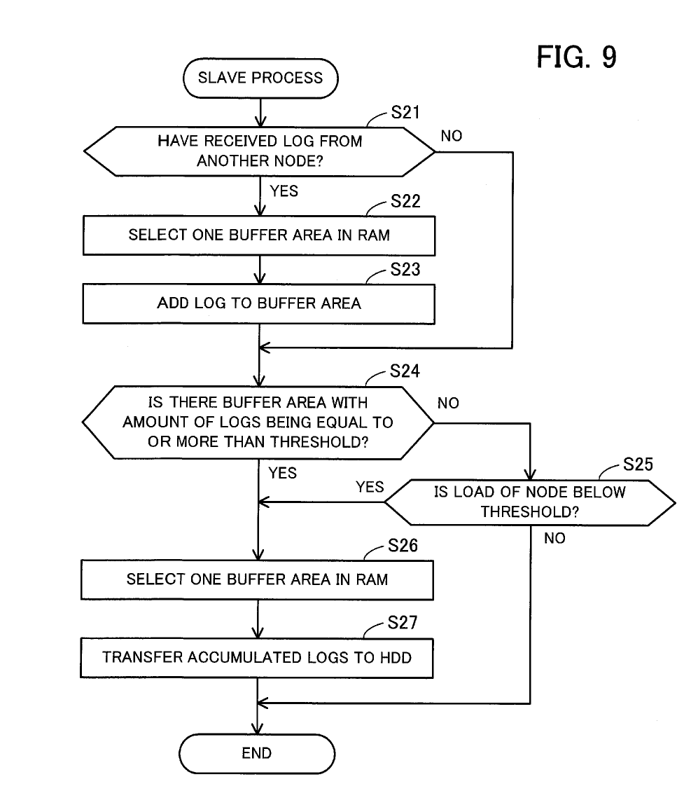

FIG. 9 is a flowchart illustrating a procedure example of a slave process. Here, the procedure of the slave process is described for the case where the node 100 carries out the slave process. The node 100 repeatedly carries out the slave process illustrated in FIG. 9. Note that the nodes 100-1 to 100-6 individually carry out a similar slave process to that of the node 100.

[Step S21] The log managing unit 154 determines whether to have received a log from another node. If having received a log, the process moves to step S22. If not, the process moves to step S24.

[Step S22] The log managing unit 154 selects, among the plurality of buffer areas in the log buffer 130, a buffer area corresponding to a key designated in the log.

[Step S23] The log managing unit 154 adds the received log to the selected buffer area.

[Step S24] For each of the buffer areas in the log buffer 130, the log managing unit 154 recognizes the amount of logs (for example, the log size or the number of data manipulation instructions) accumulated in the buffer area. Then, the log managing unit 154 determines whether there is a buffer area whose amount of logs is equal to or more than a predetermined threshold. If the determination is affirmative, the process moves to step S26. If not, the process moves to step S25.

[Step S25] The log managing unit 154 measures the load on the node 100 to determine whether the load is below a threshold. As an index of the load on the node 100, for example, CPU utilization or access frequency to the HDD 103 may be used. The log managing unit 154 may measure the load associated with the master process. If the load on the node 100 is below the threshold, the process moves to step S26. If not (i.e., the load is equal to or more than the threshold), the slave process is ended.

[Step S26] The log managing unit 154 selects one of the buffer areas in the log buffer 130. If there is one or more buffer areas whose amount of logs is equal to or more than the threshold, a buffer area is selected from among them. If there is no such a buffer area, any buffer area may be selected, or a buffer area having the largest amount of logs may be selected.

[Step S27] The log managing unit 154 writes logs accumulated in the selected buffer area into the log storing unit 120. At this point, it is possible to sequentially and collectively write logs for a plurality of data manipulation instructions into the log storing unit 120. The logs once written into the log storing unit 120 may be deleted from the log buffer 130. Subsequently, the slave process is ended.

In the above-described manner, the log managing unit 154 accumulates logs in the RAM 102 after receiving each log from the master node instead of immediately writing each received log into the HDD 103. Then, the log managing unit 154 waits until the amount of logs accumulated in the RAM 102 increases or the load on the node 100 is reduced, and then collectively transfers logs for a plurality of data manipulation instructions to the HDD 103.

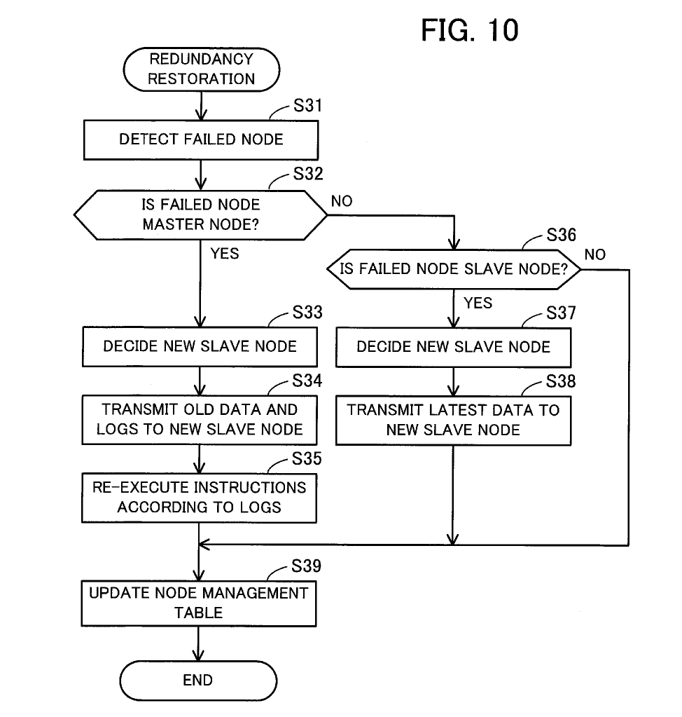

FIG. 10 is a flowchart illustrating a procedure example of redundancy restoration. Here, the procedure of the redundancy restoration is described for the case where the node 100 has detected a failure in another node. Note that the nodes 100-1 to 100-6 individually carry out similar redundancy restoration to that of the node 100.

[Step S31] The node monitoring unit 155 detects a failure in another node.

[Step S32] With reference to the node management table 141 stored in the node information storing unit 140, the node monitoring unit 155 determines whether the failed node is the master node of data for which the node 100 is in charge of the slave process. If the determination is affirmative, the process moves step S33. If not, the process moves to step S36.

[Step S33] The master restoring unit 161 determines that the node 100 becomes a master node of the data in place of the failed master node. In addition, the master restoring unit 161 decides a new slave node among normal nodes. The new slave node is, for example, the node 100-1 which is a node located in the hash space immediately after the node 100, as described in FIG. 4.

[Step S34] The master restoring unit 161 transmits, to the new slave node, relevant data stored in the data storing unit 110 and logs stored in the log storing unit 120. The new slave node re-executes write instructions indicated by the logs on the old data (to which the logs have yet to be applied) to thereby restore the latest data.

[Step S35] The master restoring unit 161 re-executes write instructions indicated by the logs stored in the log storing unit 120 to thereby restore, on the data storing unit 110, the latest data stored in the failed master node. At this point, the master restoring unit 161 re-executes logs with respect to each of the divided storage areas in the log storing unit 120, which enables successive data writing into locations close to each other in the data storing unit 110. Subsequently, the process moves to step S39.

Note that, as described above, first the logs may be applied to the data storing unit 110 to restore the latest data (step S35), and the restored latest data may be then transmitted to the new slave node. In that case, the new slave node does not have to carry out the log application.

[Step S36] With reference to the node management table 141, the node monitoring unit 155 determines whether the failed node is the slave node of data for which the node 100 is in charge of the master process. If the determination is affirmative, the process moves to step S37. If not, the node monitoring unit 155 proceeds to step S39.

[Step S37] The slave restoring unit 162 decides, among normal nodes, a new slave node in place of the failed slave node. The new slave node is, for example, a node located in the hash space immediately after the failed slave node.

[Step S38] The slave restoring unit 162 transmits relevant data stored in the data storing unit 110 to the new slave node. Since the node 100 is the master node, the data storing unit 110 stores therein the latest data for the relevant data. Therefore, the latest data transmitted from the node 100 are stored in the new slave node.

[Step S39] The node monitoring unit 155 calculates data re-allocation for the case where the failed node is removed, and updates the node management table 141. For example, as described in FIG. 4, a node located in the hash space immediately after the failed node undertakes the master process and the slave process of the failed node. In addition, for example, the second node located after the failed node undertakes the slave process of which the node located immediately after the failed node has been in charge.

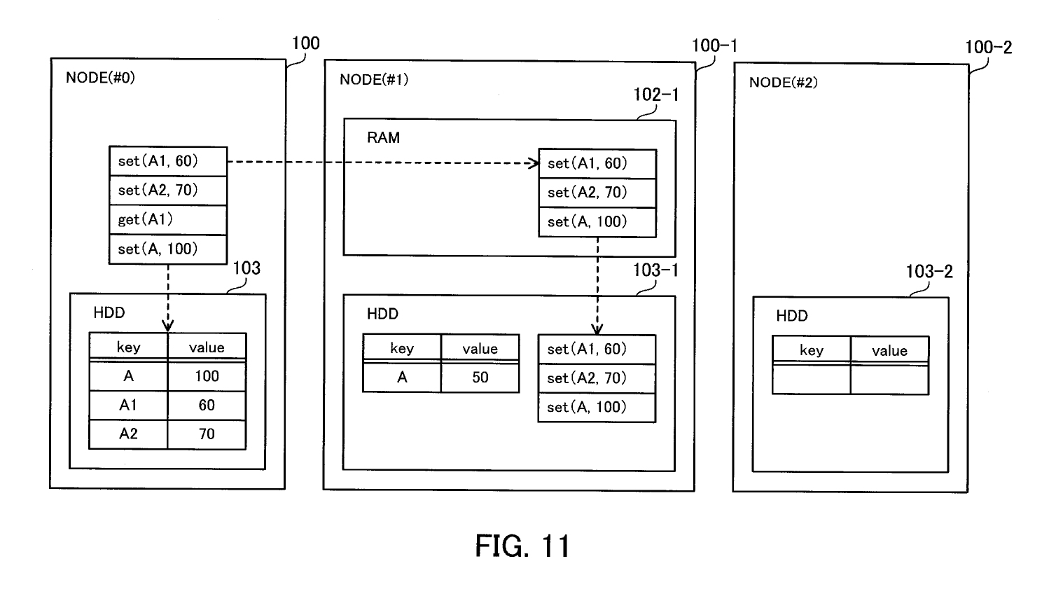

FIG. 11 illustrates a first example of communication among nodes. Assume here that the node 100 is a master node of data records with keys=A, A1, and A2 and the node 100-1 is a slave node of the data records with keys=A, A1, and A2. Here, the data redundancy is 2 (i.e., the same data are stored in two nodes) and the node 100-2 is in charge of neither the master process nor the slave process of the data records with keys=A, A1, and A2. Note that FIG. 11 omits illustration of the slave process for other data records carried out by the node 100 and the master process for other data records carried out by the node 100-1.

The node 100 receives data manipulation instructions each designating the individual data records with keys=A, A1, and A2. For example, the node 100 sequentially receives a write instruction for value=60 for the data record with key=A1; a write instruction for value=70 for the data record with key=A2; a read instruction for the data record with key=A1; and a write instruction for value=100 for the data record with key=A. Then, the node 100 sequentially executes these data manipulation instructions. With this, the following key-value data records are stored in the HDD 103 of the node 100: key=A, value=100; key=A1, value=60; and key=A2, value=70.

In addition, the node 100 sequentially transmits logs indicating the executed write instructions to the node 100-1. For example, the node 100 sequentially transmits, to the node 100-1, logs indicating the write instruction for value=60 for the data record with key=A1; the write instruction for value=70 for the data record with key=A2; and the write instruction for value=100 for the data record with key=A. A log indicating the read instruction for the data record with key=A1 may or may not be transmitted to the node 100-1.

The node 100-1 temporarily accumulates the logs received from the node 100 in the RAM 102-1 of the node 100-1 instead of writing the logs individually into the HDD 103-1 of the node 100-1 right away. Then, when the amount of logs accumulated in the RAM 102-1 has reached a threshold or when the load of the node 100-1 has become low, the node 100-1 collectively transfers the accumulated logs to the HDD 103-1. For example, the node 100-1 writes, into the HDD 103-1, the logs each indicating the write instruction for value=60 for the data record with key=A1; the write instruction for value=70 for the data record with key=A2; and the write instruction for value=100 for the data record with key=A.

At this point, the node 100-1 does not immediately reflect the logs stored in the HDD 103-1 in a backup copy corresponding to the data held by the node 100. Therefore, the latest data stored in the node 100, for which the node 100 is in charge of the master process, become temporarily inconsistent with the backup copy stored in the node 100-1 in correspondence with the data of the node 100, for which the node 100-1 is in charge of the slave process. That is, while the data composed of data records with keys=A, A1, an A2 held by the node 100 are the latest, the backup copy held by the node 100-1 is not the latest. Note however that the node 100-1 is able to restore the latest data afterward (for example, when a failure occurs in the node 100) by applying the logs stored in the HDD 103-1 to the backup copy.

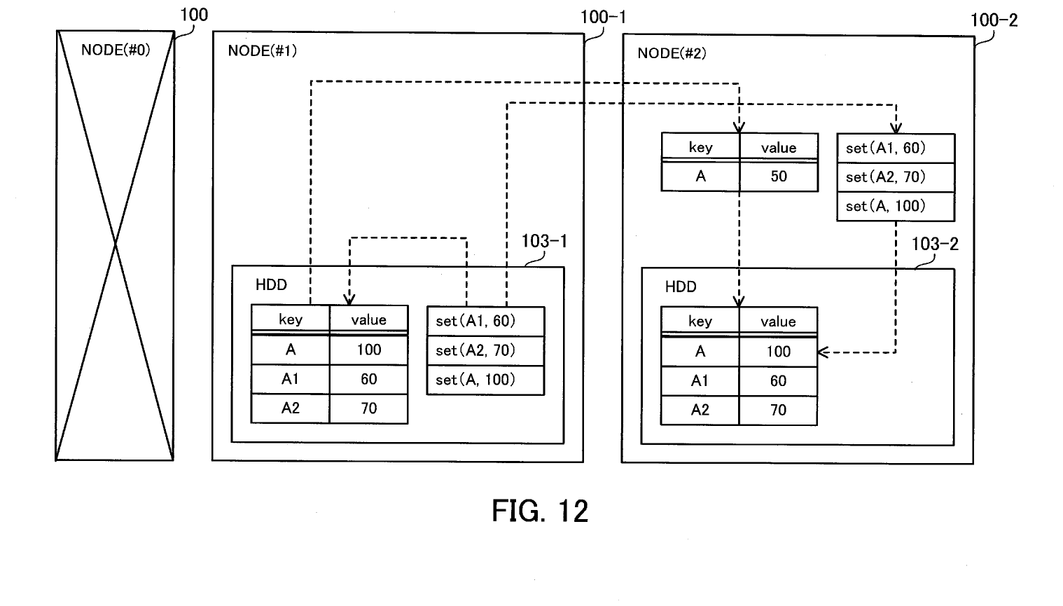

FIG. 12 illustrates a second example of communication among nodes. Assume the case where a failure has occurred in the node 100 in the setting of FIG. 11. Since being the slave node for the data records with keys=A, A1, and A2, the node 100-1 controls restoration of data redundancy when detecting a failure in the node 100 which is the master node for the data records with keys=A, A1, and A2.

The node 100-1 determines to become a master node of the data records with keys=A, A1, and A2 in place of the node 100. Then, the node 100-1 transmits the backup copy (before log application) and the logs for keys=A, A1, and A2 to the node 100-2, which is to be a slave node in place of the node 100-1. Subsequently, the node 100-1 applies the logs to the old backup copy to restore the latest data held by the node 100. With this, for example, the latest data composed of data records with key=A, value=100; key=A1, value=60; and key=A2, value=70 are restored in the HDD 103-1.

Upon receiving the old backup copy and the logs from the node 100-1, the node 100-2 applies the logs to the backup copy to restore the latest data. With this, for example, the latest data composed of data records with key=A, value=100; key=A1, value=60; and key=A2, value=70 are restored in the HDD 103-2 of the node 100-2. From this point forward, the node 100-2 functions as the slave node for the data records with keys=A, A1, and A2. The data restoration of the node 100-2 may be carried out in parallel with the data restoration of the node 100-1.

Note however that the node 100-1 may transmit, to the node 100-2, the latest data acquired by applying the logs to the backup copy. Alternatively, the node 100-2 functioning as a new slave node may hold the old backup copy and the logs, rather than restoring the latest data as described above. In this case, the latest data are restored, for example, when the node 100-1 experiences a failure.

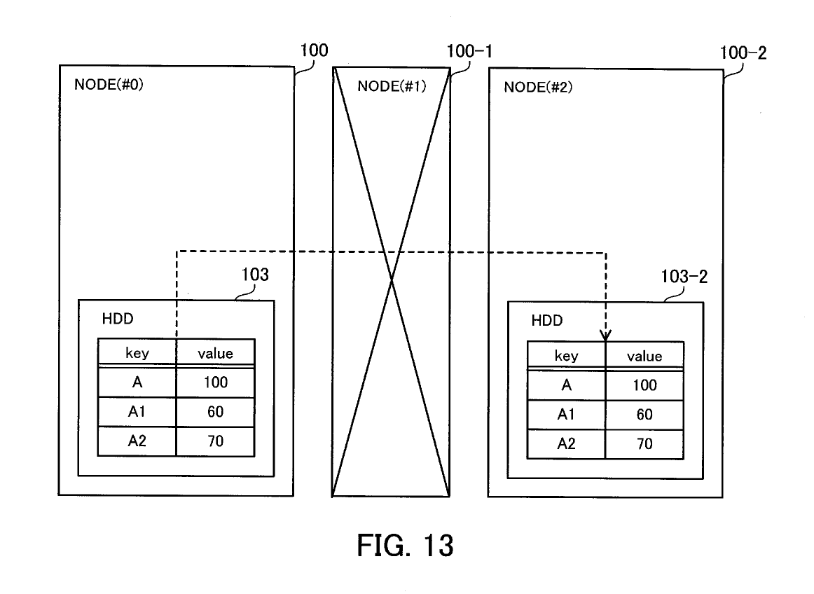

FIG. 13 illustrates a third example of communication among nodes. Assume the case where a failure has occurred in the node 100-1 in the setting of FIG. 11. Since being the master node for the data records with keys=A, A1, and A2, the node 100 controls restoration of data redundancy when detecting the failure in the node 100-1, which is the slave node for the data records with keys=A, A1, and A2.

The node 100 transmits the latest data composed of data records with keys=A, A1, and A2 to the node 100-2, which is to be a slave node in place of the node 100-1. The node 100-2 stores the latest data received from the node 100 in the HDD 103-2 of the node 100-2. For example, the latest data composed of the data records with key=A, value=100; key=A1, value=60; and key=A2, value=70 are stored in the HDD 103-2 of the node 100-2. From this point forward, the node 100-2 functions as the slave node of the data records with keys=A, A1, and A2.

Changes in the data allocation have been described above with an example where the data redundancy is 2 (the same data are stored in two nodes). Note however that the data redundancy may be set to 3 or more. In that case, among three or more nodes individually storing the same data, one node becomes a master node and the remaining two or more nodes become slave nodes. The two or more slave nodes are preferably ranked as a first slave node, a second slave node, and so on. The first slave node becomes a new master node when its immediate superior node (original master node) fails. Each of the second and following slave nodes moves up by one place in the ranking when one of its superior nodes fails. In that case, a new slave node is added to the bottom of the ranking.

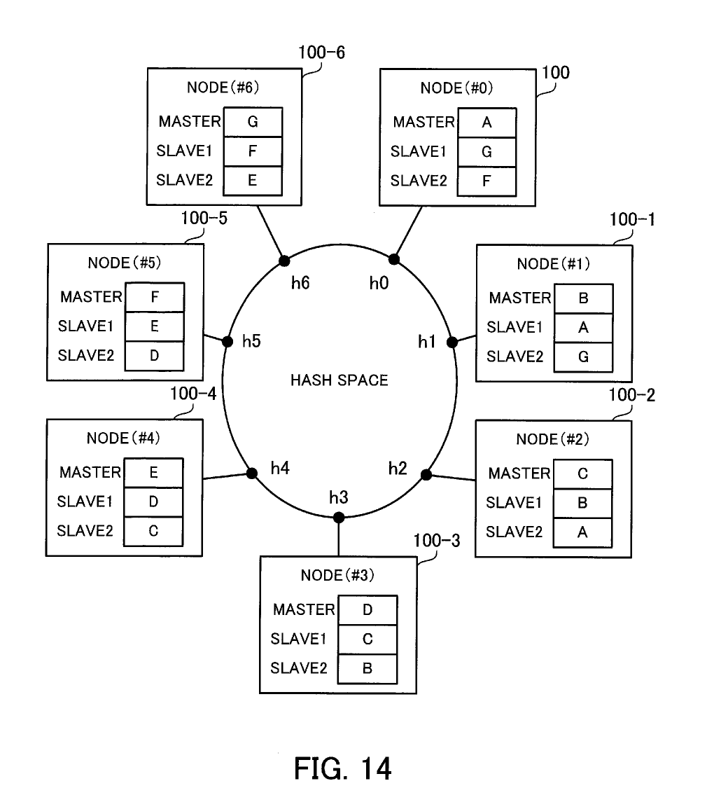

FIG. 14 illustrates another data allocation example. Assume the case where the data redundancy is set to 3, that is, data are redundantly stored across three nodes. Each node is a master node responsible for data belonging to a region in the hash space between the node and its predecessor, as in the case of FIG. 3. A successor located in the hash space immediately after each master node responsible for data is a first slave node of the data, and a second successor after the master node is a second slave node of the data.

Assuming as an example that h( ) is a hash function, the node 100 is a master node of data record A belonging to the region h6<h(key)≦2^{L}−1 or the region 0≦h(key)≦h0, and the nodes 100-1 and 100-2 are a first slave node and a second slave node, respectively, of data record A. In addition, the node 100-1 is a master node of data record B belonging to the region h0<h(key)≦h1, and the nodes 100-2 and 100-3 are a first slave node and a second slave node, respectively, of data record B. Similarly, the node 100-2 is a master node of data record C belonging to the region h1<h(key)≦h2, and the nodes 100-3 and 100-4 are a first slave node and a second slave node, respectively, of data record C.

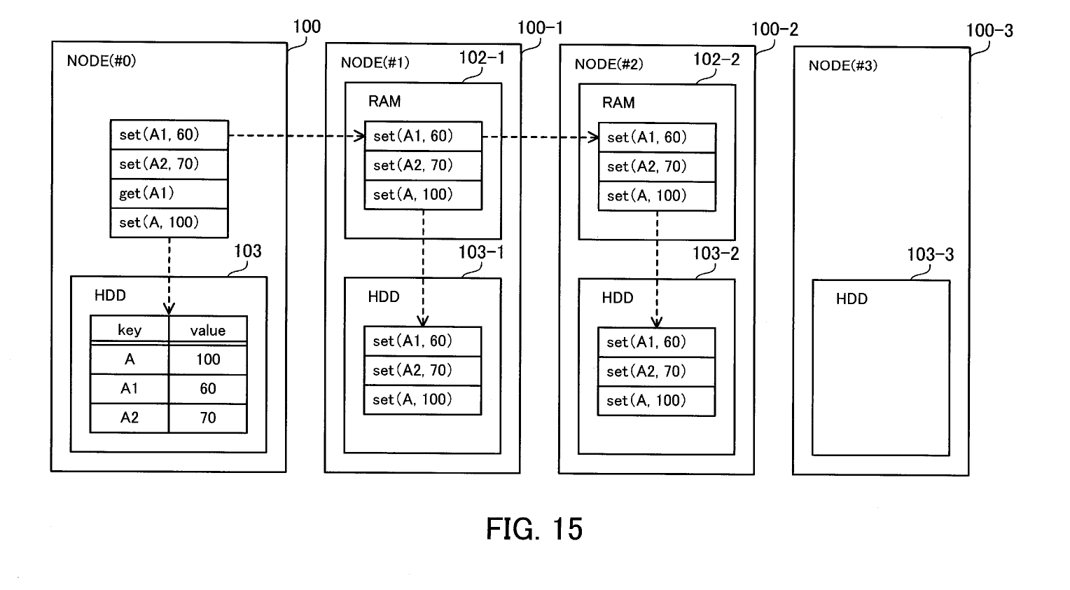

FIG. 15 illustrates a fourth example of communication among nodes. Assume here that the node 100 is the master node of data records with keys=A, A1, and A2, and the nodes 100-1 and 100-2 are the first slave node and the second slave node, respectively, of the data records with keys=A, A1, and A2. Here, the data redundancy is 3 (the same data are stored across three nodes) and the node 100-3 is in charge of neither the master process nor the slave process of the data records with keys=A, A1, and A2.

The node 100 receives data manipulation instructions each designating the individual data records with keys=A, A1, and A2, and then sequentially executes these data manipulation instructions, as in the case of the redundancy set to 2 (the example of FIG. 11). In addition, the node 100 sequentially transmits logs indicating the executed write instructions to the node 100-1 functioning as the first slave node. For example, the node 100 sequentially transmits, to the node 100-1, logs each indicating a write instruction for value=60 for the data record with key=A1; a write instruction for value=70 for the data record with key=A2; and a write instruction for value=100 for the data record with key=A.

The node 100-1 temporarily accumulates the logs received from the node 100 in the RAM 102-1 of the node 100-1 instead of writing the logs individually into the HDD 103-1 of the node 100-1 right away, as in the case of the redundancy set to 2 (the example of FIG. 11). Then, when the amount of logs accumulated in the RAM 102-1 has reached a threshold or when the load of the node 100-1 has become low, the node 100-1 collectively transfers the accumulated logs to the HDD 103-1.

In addition, the node 100-1 copies the logs received from the node 100 and then transfers the copied logs to the node 100-2 functioning as the second slave node. Note however that the node 100 may copy the logs and transfer the copied logs to the individual nodes 100-1 and 100-2, instead of the node 100-1 transferring the logs to the node 100-2. The node 100-2 temporarily accumulates the received logs in the RAM 102-2 of the node 100-2 instead of writing the logs individually into the HDD 103-2 of the node 100-2 right away. Then, when the amount of logs accumulated in the RAM 102-2 has reached a threshold or when the load of the node 100-2 has become low, the node 100-2 collectively transfers the accumulated logs to the HDD 103-2.

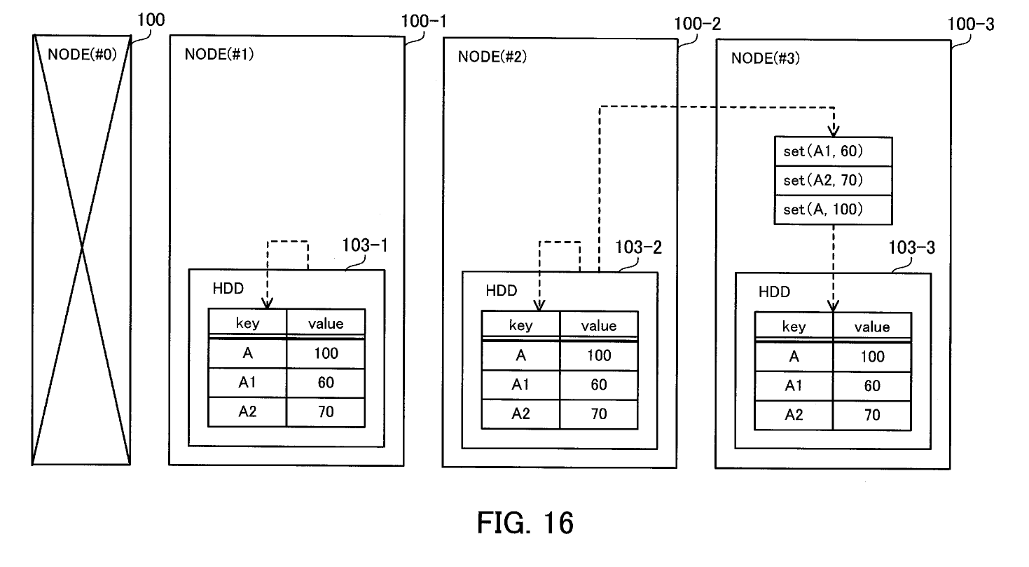

FIG. 16 illustrates a fifth example of communication among nodes. Assume the case where a failure has occurred in the node 100 in the setting of FIG. 15. Since being the slave nodes of the data records with keys=A, A1, and A2, the nodes 100-1 and 100-2 control restoration of data redundancy when detecting the failure in the node 100 which is the master node of the data records with keys=A, A1, and A2.

The node 100-1 determines to become a new master node of the data records with keys=A, A1, and A2 in place of the node 100. Then, the node 100-1 applies the logs to the old backup copy to restore the latest data held by the node 100. With this, for example, the latest data composed of data records with key=A, value=100; key=A1, value=60; and key=A2, value=70 are restored in the HDD 103-1 of the node 100-1.

The node 100-2 determines to become a first slave node for the data records with keys=A, A1, and A2 in place of the node 100-1. Then, the node 100-2 transmits the backup copy (before log application) and the logs for keys=A, A1, and A2 to the node 100-3, which is to be a second slave node in place of the node 100-2. Since having been the second slave node, the node 100-2 need not acquire the backup copy and the logs for keys=A, A1, and A2 from the node 100-1. As is the case with the node 100-1, the node 100-2 is able to restore the latest data by applying the logs to the old backup copy. With this, for example, the latest data composed of the data records with key=A, value=100; key=A1, value=60; and key=A2, value=70 are restored in the HDD 103-2 of the node 100-2.

Upon receiving the old backup copy and the logs from the node 100-2, the node 100-3 applies the logs to the old backup copy to restore the latest data. With this, for example, the latest data composed of the data records with key=A, value=100; key=A1, value=60; and key=A2, value=70 are restored in the HDD 103-3 of the node 100-3. The individual data restoration of the nodes 100-1 to 100-3 may be carried out in parallel with one another.

Note however that not the node 100-2 having been the second slave node but the node 100-1 having been the first slave node may transmit the backup copy and the logs to the node 100-3. Alternatively, the node 100-2 (or the node 100-1) may first restore the latest data, and then transmit a copy of the latest data to the node 100-3. In addition, the node 100-2 having changed from the second slave node to the first slave node may hold the old backup copy and the logs, rather than restoring the latest data as described above. In this case, the latest data are restored, for example, when the node 100-1 experiences a failure. In the same fashion, the node 100-3 may be designed not to restore the latest data.

According to the information processing system of the second embodiment, access load from the client terminal 31 is distributed since the nodes 100 and 100-1 to 100-6 share the master processes. In addition, one or more nodes different from each node in charge of the master process for data manage a backup copy of the data to achieve data redundancy, thus improving fault tolerance. In addition, each node being in charge of both the master process and the slave process enables efficient use of the computer processing power.

In addition, when a master node executes a write instruction, a log for the write instruction is stored in one or more corresponding slave nodes instead of the write operation being immediately reflected in a backup copy held by each of the slave nodes. This reduces random access to the HDDs associated with the slave processes, alleviating the adverse effect on the performance of the master process. Further, logs are temporarily accumulated in the RAM rather than being written into the HDD each time a log is transmitted from the master node to each of the slave nodes, and accumulated logs for a plurality of write instructions are then sequentially written into the HDD. This enables a further reduction in random access to the HDD associated with the slave process. Therefore, even if HDDs providing relatively slow random access are used for data management, it is possible to control the performance degradation of the master process due to the slave process, thereby improving the throughput.

Note that, as described above, the information processing according to the first embodiment is implemented by causing the nodes 10 and 20 to execute a program. In addition, the information processing according to the second embodiment is implemented by causing the client terminal 31 and the nodes 100 and 100-1 to 100-6 to execute a program. Such a program may be recorded on computer-readable recording media (for example, the recording medium 43). Usable recording media for this purpose include, for example, a magnetic disk, an optical disk, a magneto-optical disk, and a semiconductor memory. Examples of the magnetic disk are a flexible disk (FD) and a HDD. Examples of the optical disk are a compact disc (CD), a CD-R (recordable), a CD-RW (rewritable), a DVD, a DVD-R, and a DVD-RW. The program may be recorded on portable recording media for distribution. In that case, the program may be copied (installed) from a portable recording medium to another recording medium, such as a HDD (for example, the HDD 103), and then executed.

According to one aspect, it is possible to alleviate the effect of the data redundancy management on the performance of other processing.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the designation relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A non-transitory computer-readable storage medium storing a computer program, the computer program causing a computer to perform a process, which computer is used as a second node in a system including a first node responsible for a first data group and the second node responsible for a second data group and managing a backup copy of the first data group, the process comprising:
receiving, from the first node, a log indicating an instruction executed on a data record belonging to the first data group, and storing the received log in a memory of the computer; and
writing logs accumulated in the memory, each of which indicates one of the instruction in plurality, into a storage device of the computer different from the memory when a predetermined condition is satisfied.

2. The non-transitory computer-readable storage medium according to claim 1, wherein the predetermined condition is load on the computer being below a threshold.

3. The non-transitory computer-readable storage medium according to claim 1, wherein the predetermined condition is an amount of the logs accumulated in the memory being equal to or more than a threshold.

4. The non-transitory computer-readable storage medium according to claim 1, wherein
the memory includes a plurality of buffer areas,
each of the logs is stored in one of the buffer areas determined according to a key of the data record designated by one of the instructions which corresponds to the log, and
the writing of the logs from the memory to the storage device is performed with respect to each of the buffer areas.

5. The non-transitory computer-readable storage medium according to claim 1, the process further comprising:
detecting a failure in the first node; and
causing a third node to manage the backup copy of the first data group by transmitting to the third node, in response to the detection of the failure, the logs written into the storage device or the first data group restored based on the logs.

6. A data management method performed by a system including a first node responsible for a first data group and a second node responsible for a second data group and managing a backup copy of the first data group, the data management method comprising:
transmitting a log indicating an instruction executed on a data record belonging to the first data group from the first node to the second node;
storing the transmitted log in a memory of the second node; and
writing, by a processor of the second node, logs accumulated in the memory, each of which indicates one of the instruction in plurality, into a storage device of the second node different from the memory when a predetermined condition is satisfied.

7. An information processing apparatus used as a second node in a system including a first node responsible for a first data group and the second node responsible for a second data group and managing a backup copy of the first data group, the information processing apparatus comprising:
a memory;
a storage device different from the memory;
a receiving unit configured to receive, from the first node, a log indicating an instruction executed on a data record belonging to the first data group; and
a processor configured to store the received log in the memory, and write logs accumulated in the memory, each of which indicates one of the instruction in plurality, into the storage device when a predetermined condition is satisfied.
